(19) United States
(12) Patent Application Publication
(10) Pub. No.: US 2018/0213769 A1
(43) Pub. Date: Aug. 2, 2018

(54) Shark Repelling Assembly

(71) Applicant: Nathan Clowe, Aurora, CO (US)

(72) Inventor: Nathan Clowe, Aurora, CO (US)

(21) Appl. No.: 15/417,739

(22) Filed: Jan. 27, 2017

(51) Int. Cl. A01M 29/24; E02B 1/00

(52) U.S. Cl. CPC A01M 29/24; E02B 1/006

(57) ABSTRACT

A shark repelling assembly includes a conduit that is submerged in water to surround a swimming area. A plurality of radiation units is provided and each of the radiation units is coupled to the conduit. Each of the radiation units emits electromagnetic energy thereby facilitating each of the radiation units to repel a shark from the swimming area. The radiation units are spaced apart from each other and are distributed along an entire length of the conduit. A base unit is provided and the base unit is positioned on land. The base unit is in electrical communication with each of the radiation units and the base unit controls operational parameters of the plurality of radiation units.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to repelling devices and more particularly pertains to a new repelling device for repelling sharks from a swimming area.

### BRIEF SUMMARY OF THE INVENTION

An embodiment of the disclosure meets the needs presented above by generally comprising a conduit that is be submerged in water to surround a swimming area. A plurality of radiation units is provided and each of the radiation units is coupled to the conduit. Each of the radiation units emits electromagnetic energy thereby facilitating each of the radiation units to repel a shark from the swimming area. The radiation units are spaced apart from each other and are distributed along an entire length of the conduit. A base unit is provided and the base unit is positioned on land. The base unit is in electrical communication with each of the radiation units and the base unit controls operational parameters of the plurality of radiation units.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a shark repelling assembly according to an embodiment of the disclosure.

FIG. 2 is a front view of base unit of an embodiment of the disclosure.

FIG. 3 is a perspective view of radiation unit of an embodiment of the disclosure.

FIG. 4 is a cross sectional view taken along line 4-4 of FIG. 1 of an embodiment of the disclosure.

FIG. 5 is a perspective in-use view of an embodiment of the disclosure.

FIG. 6 is a schematic view of an embodiment of the disclosure.

### DETAILED DESCRIPTION OF THE INVENTION

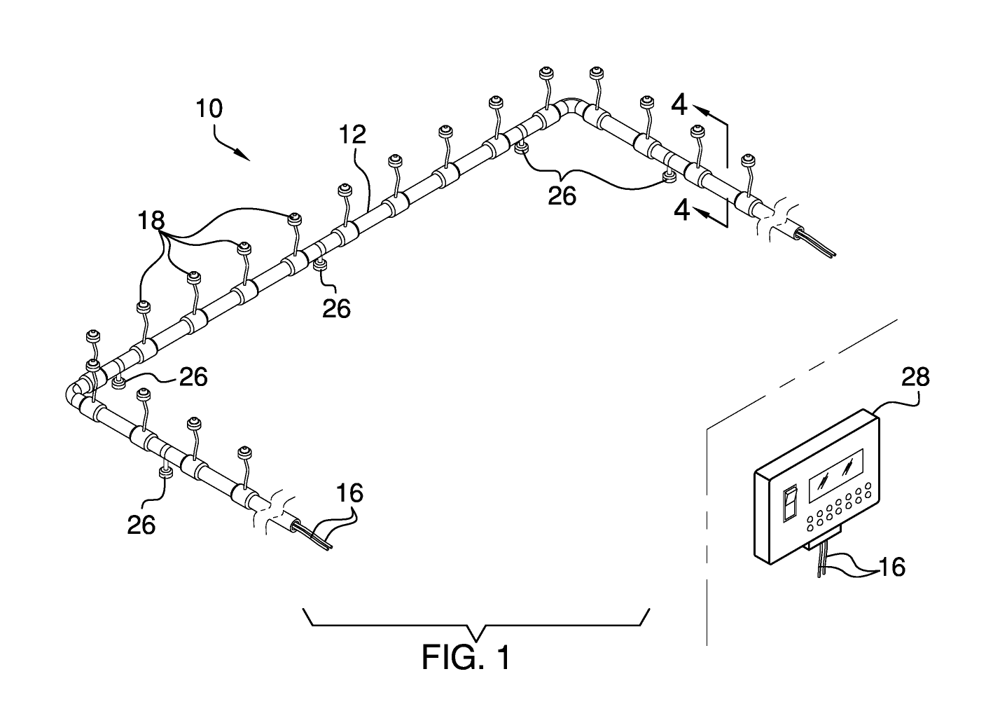

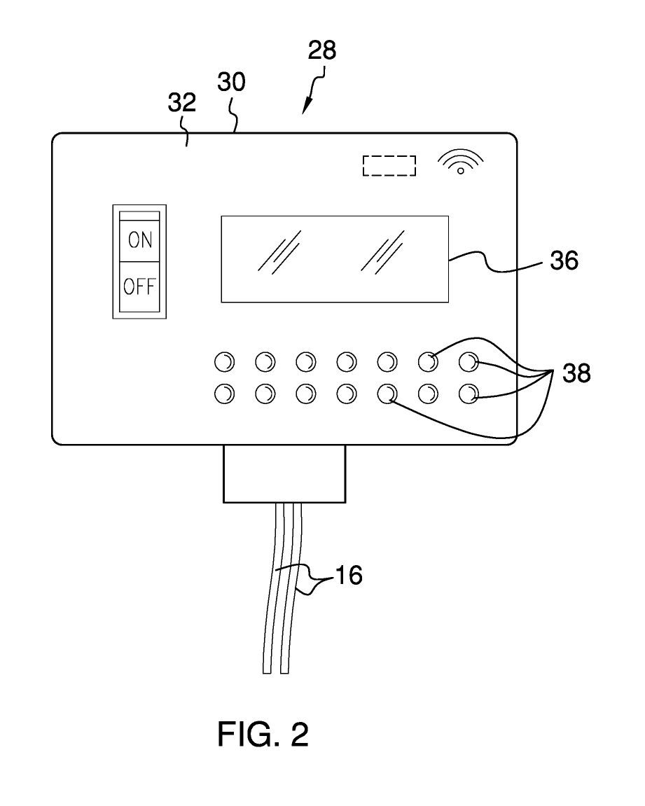

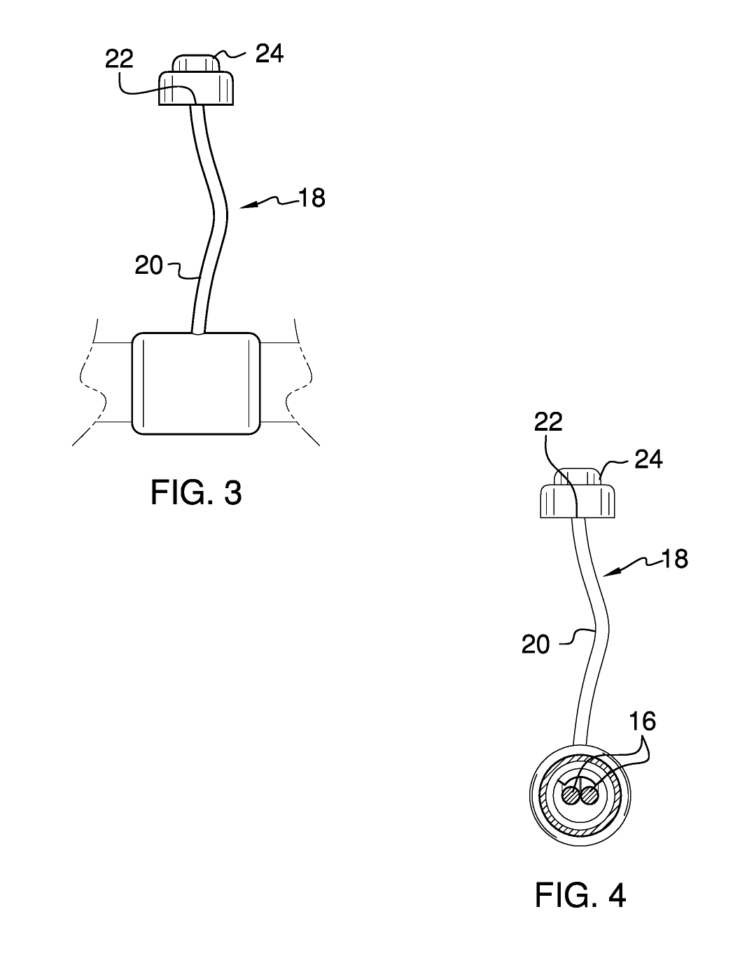

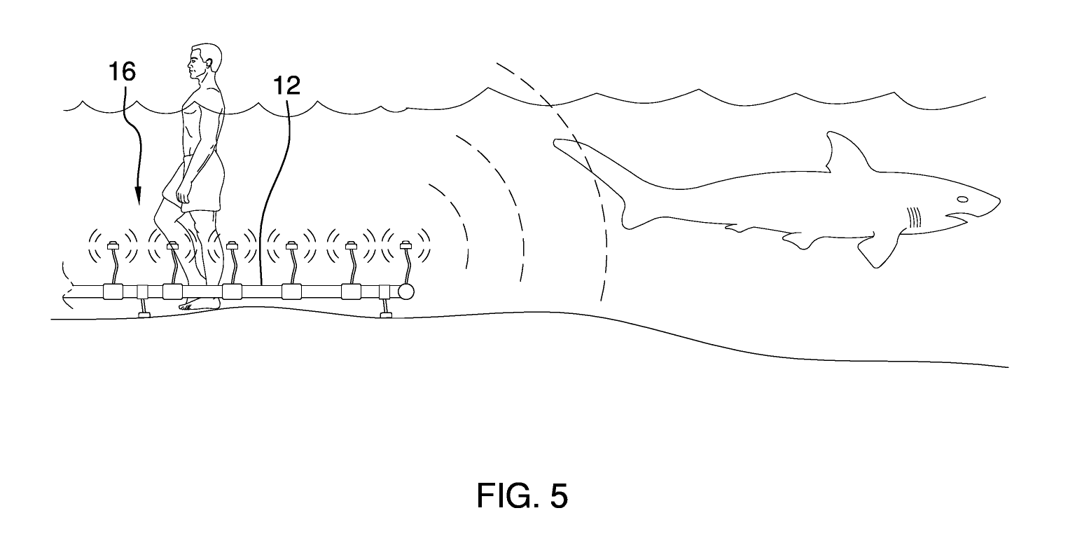

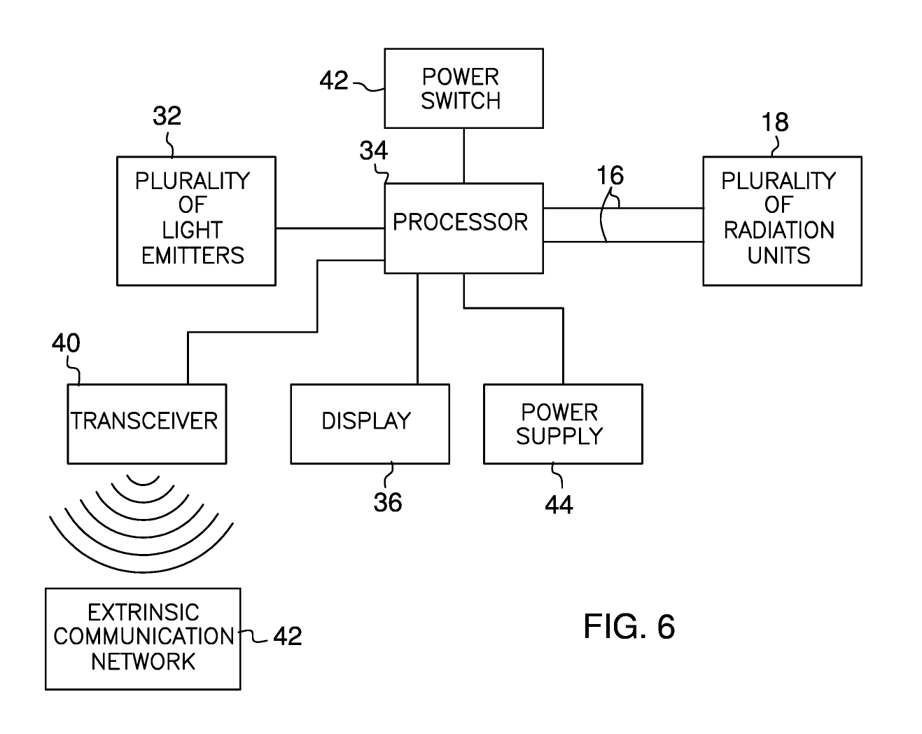

With reference now to the drawings, and in particular to FIGS. 1 through 6 thereof, a new repelling device embodying the principles and concepts of an embodiment of the disclosure and generally designated by the reference numeral 10 will be described.

As best illustrated in FIGS. 1 through 6, the shark repelling assembly 10 generally comprises a conduit 12 that may be submerged in water to surround a swimming area 14. The water may be the ocean or other body of water commonly associated with sharks. The swimming area 14 may be an area of the ocean adjacent to a beach or the like. Moreover, the conduit 12 may be shaped to define a rectangle or other geometric shape to facilitate the conduit 12 to surround the swimming area 14. A pair of first conductors 16 is provided and each of the first conductors 16 is positioned within the conduit 12.

A plurality of radiation units 18 is provided and each of the radiation units 18 is coupled to the conduit 12. Each of the radiation units 18 emits electromagnetic energy thereby facilitating each of the radiation units 18 to repel a shark from the swimming area 14. The radiation units 18 are spaced apart from each other and are distributed along an entire length of the conduit 12. Moreover, each of the radiation units 18 may be constructed of a buoyant material thereby facilitating each of the radiation units 18 to float upwardly from the conduit 12.

Each of the radiation units 18 comprises a second conductor 20 that is coupled to and extends upwardly from the conduit 12. The second conductor 20 is electrically coupled to each of the first conductors 16 and the second conductor 20 has a distal end 22 with respect to the conduit 12. A transmitter 24 is electrically coupled to the distal end 22 of the second conductor 20 and the transmitter 24 emits the electromagnetic energy. The transmitter 24 may be a radio frequency transmitter or the like. Moreover, the transmitter 24 may emit the electromagnetic energy at a frequency that corresponds to a sensitivity range of ampullae of Lorenzini in the sharks. In this manner the transmitter 24 causes the ampullae of Lorenzini in the shark to be over stimulated thereby forcing the shark to turn away from the transmitter 24.

A plurality of anchors 26 is provided and each of the anchors 26 is coupled to and extends downwardly from the conduit 12. Each of the anchors 26 engages a bottom of the swimming area 14 such that the conduit 12 is retained in the swimming area 14. Each of the anchors 26 may engage the bottom of the swimming area 14 via any conventional means to include, but not be limited to, a weight or a stake for piercing the bottom of the swimming area 14.

A base unit 28 is provided and the base unit 28 is positioned on land. The base unit 28 is in electrical communication with each of the radiation units 18 and the base unit 28 controls operational parameters of the plurality of radiation units 18. The base unit 28 comprises a housing 30 that has a front wall 32 and the housing 30 is positioned on land. In this way the housing 30 is accessible to a user for controlling operational parameters of the radiation units 18.

Each of the first conductors 16 is coupled to the housing 30. A processor 34 is provided and the processor 34 is positioned within the housing 30. The processor 34 is electrically coupled to each of the first conductors 16. The processor 34 may be an electronic processor or the like.

A display 36 is coupled to the front wall 32 of the housing 30. The display 36 is electrically coupled to the processor 34 such that the display 36 displays operational parameters of the processor 34. The display 36 may be an LCD display or the like. A plurality of light emitters 38 is provided and each of the light emitters 38 is coupled to the front wall 32. Each of the light emitters 38 is electrically coupled to the processor 34 and each the light emitters 38 may be a LED or the like. Each of the light emitters 38 is in electrical communication with an associated one of the radiation units 18 such that each of the light emitters 38 communicates an operational status of the associated radiation units 18. Each of the light emitters 38 may be turned on when the associated radiation unit 18 is turned on. Moreover, each of the light emitters 38 may be turned off when the associated radiation unit 18 is turned off.

A transceiver 40 is provided and the transceiver 40 is positioned within the housing 30. The transceiver 40 is in electrical communication with an extrinsic communication network 42. The transceiver 40 is electrically coupled to the processor 34 and the transceiver 40 may be a radio frequency transceiver or the like. The transceiver 40 may employ a WPAN signal and the extrinsic communication network 42 may be the internet or the like. In this way the functional status of the plurality of radiation units 18 may be remotely monitored.

A power switch 42 is provided and the power switch 42 is coupled to the housing 30. The power switch 42 is electrically coupled to the processor 34 such that the power switch 42 turns the processor 34 on and off. A power supply 44 is positioned within the housing 30 and the power supply 44 is electrically coupled to the processor 34. The power supply 44 comprises at least one battery. Moreover, the power supply 44 may be electrically coupled to a power source such as an electrical outlet or the like.

In use, the conduit 12 is submerged and the conduit 12 is positioned to surround the swimming area 14. Each of the anchors 26 is manipulated to engage the bottom of the swimming area 14 to inhibit the conduit 12 from moving with tides, current or other motions associated with the ocean. The power switch 42 is manipulated to turn on each of the radiation units 18. The transmitter 24 corresponding to each of the radiation units 18 emits the electromagnetic energy into the water. In this way each of the radiation units 18 inhibits sharks from entering the swimming area 14 thereby enhancing safety with respect to swimmers in the swimming area 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A shark repelling assembly being configured to be submerged proximate a swimming area thereby facilitating sharks to be repelled from the swimming area, said assembly comprising:
a conduit being configured to be submerged in water to surround a swimming area;
a plurality of radiation units, each of said radiation units being coupled to said conduit, each of said radiation units being configured to emit electromagnetic energy thereby facilitating each of said radiation units to repel a shark from the swimming area, said radiation units being spaced apart from each other and being distributed along an entire length of said conduit; and
a base unit being configured to be positioned on land, said base unit being in electrical communication with each of said radiation units such that said base unit controls operational parameters of said plurality of radiation units.

2. The assembly according to claim 1, further comprising a pair of first conductors, each of said first conductors being positioned within said conduit.

3. The assembly according to claim 2, wherein each of said radiation units comprises a second conductor being coupled to and extending upwardly from said conduit, said second conductor being electrically coupled to each of said first conductors, said second conductor having a distal end with respect to said conduit.

4. The assembly according to claim 3, further comprising a transmitter being electrically coupled to said distal end of said second conductor wherein said transmitter is configured to emit the electromagnetic energy.

5. The assembly according to claim 1, further comprising a plurality of anchors, each of said anchors being coupled to and extending downwardly from said conduit, each of said anchors being configured to engage a bottom of the swimming area such that said conduit is retained in the swimming area.

6. The assembly according to claim 1, wherein:
said conduit has a pair of first conductors positioned therein; and
said base unit comprises a housing having a front wall, said housing being configured to be positioned on land, each of said first conductors being coupled to said housing.

7. The assembly according to claim 6, further comprising a processor being positioned within said housing, said processor being electrically coupled to each of said first conductors.

8. The assembly according to claim 7, further comprising a display being coupled to said front wall of said housing, said display being electrically coupled to said processor such that said display displays operational parameters of said processor.

9. The assembly according to claim 7, further comprising a plurality of light emitters, each of said light emitters being coupled to said front wall wherein each of said light emitters is configured to emit light outwardly therefrom, each of said light emitters being electrically coupled to said processor.

10. The assembly according to claim 9, wherein:
each of said radiation units includes a transmitter; and
each of said light emitters being in electrical communication with an associated one of said transmitters such that each of said light emitters communicates an operational status of said associated transmitter.

11. The assembly according to claim 7, further comprising a transceiver being positioned within said housing wherein said transceiver is configured to be in electrical communication with an extrinsic communication network, said transceiver being electrically coupled to said processor.

12. The assembly according to claim 7, further comprising a power switch being coupled to said housing wherein said power switch is configured to be manipulated, said power switch being electrically coupled to said processor such that said power switch turns said processor on and off.

13. The assembly according to claim 7, further comprising a power supply being positioned within said housing, said power supply being electrically coupled to said processor, said power supply comprising at least one battery.

14. A shark repelling assembly being configured to be submerged proximate a swimming area thereby facilitating sharks to be repelled from the swimming area, said assembly comprising:
a conduit being configured to be submerged in water to surround a swimming area;
a pair of first conductors, each of said first conductors being positioned within said conduit;
a plurality of radiation units, each of said radiation units being coupled to said conduit, each of said radiation units being configured to emit electromagnetic energy thereby facilitating each of said radiation units to repel a shark from the swimming area, said radiation units being spaced apart from each other and being distributed along an entire length of said conduit, each of said radiation units comprising:
a second conductor being coupled to and extending upwardly from said conduit, said second conductor being electrically coupled to each of said first conductors, said second conductor having a distal end with respect to said conduit, and
a transmitter being electrically coupled to said distal end of said second conductor wherein said transmitter is configured to emit the electromagnetic energy;
a plurality of anchors, each of said anchors being coupled to and extending downwardly from said conduit, each of said anchors being configured to engage a bottom of the swimming area such that said conduit is retained in the swimming area; and
a base unit being configured to be positioned on land, said base unit being in electrical communication with each of said radiation units such that said base unit controls operational parameters of said plurality of radiation units, said base unit comprising:
a housing having a front wall, said housing being configured to be positioned on land, each of said first conductors being coupled to said housing,
a processor being positioned within said housing, said processor being electrically coupled to each of said first conductors,
a display being coupled to said front wall of said housing, said display being electrically coupled to said processor such that said display displays operational parameters of said processor,
a plurality of light emitters, each of said light emitters being coupled to said front wall wherein each of said light emitters is configured to emit light outwardly therefrom, each of said light emitters being electrically coupled to said processor, each of said light emitters being in electrical communication with an associated one of said transmitters such that each of said light emitters communicates an operational status of said associated transmitter,
a transceiver being positioned within said housing wherein said transceiver is configured to be in electrical communication with an extrinsic communication network, said transceiver being electrically coupled to said processor,
a power switch being coupled to said housing wherein said power switch is configured to be manipulated, said power switch being electrically coupled to said processor such that said power switch turns said processor on and off, and
a power supply being positioned within said housing, said power supply being electrically coupled to said processor, said power supply comprising at least one battery.
